(19) United States
(12) Patent Application Publication
(10) Pub. No.: US 2006/0118362 A1
(43) Pub. Date: Jun. 8, 2006

(54) Automated hose clearing after refrigerant charging method and apparatus

(76) Inventors: William Brown, Owatonna, MN (US); Walter D. Murray, Pioneer, OH (US)

Correspondence Address: BAKER & HOSTETLER LLP;Washington Square, Suite 1100, 1050 Connecticut Avenue, N.W., WASHINGTON, DC, 20036, US

(21) Appl. No.: 10/998,827

(22) Filed: Nov. 30, 2004

(51) Int. Cl. F16N 33/00

(52) U.S. Cl. 184/1.5

(57) ABSTRACT

An automated hose clearing after refrigerant charge method and appropriate apparatus is provided. The method includes, determining if a pressure differential between a high and low pressure hose exceeds a predetermined threshold and temporarily providing fluid communication between the interiors of the high and low-pressure hoses.

### FIELD OF THE INVENTION

The present invention relates generally to machines for charging air conditioning systems in vehicles. More particularly, the present invention relates to clearing the high-pressure hose of refrigerant after charging a vehicle's air conditioning system.

### BACKGROUND OF THE INVENTION

For a variety of reasons, air conditioning systems (A/C systems) require maintenance. One common maintenance procedure for an A/C system is to add refrigerant to the A/C system. Adding refrigerant is commonly referred to as charging the system. Automobile A/C systems are often serviced with charging machines (sometimes called recovery units). When charging refrigerant in A/C systems, adding the correct amount of refrigerant is important because the amount of refrigerant that enters an A/C system during a charge can effect system performance.

Charging machines are often connected to an A/C system in two places. A hose will connect the charging machine and the A/C system at a point near the discharge side of the A/C system compressor. This hose is referred to as the high-pressure hose or high-side hose because the pressure of the refrigerant is highest at the discharge of the compressor. A second hose connects the A/C system with the charger near the inlet of the compressor. This second hose is referred to as the low-pressure or low-side hose.

Many charging or recovery units measure the amount of refrigerant entering an A/C system without taking into account refrigerant in the hoses connecting the recovery unit with the A/C system. Some connecting hoses may be 96 inches in length. After charging some A/C systems, the high-side hose of a recovery unit may be filled with a significant amount of high-pressure liquid refrigerant. Disconnecting the high-side hose while it is full of refrigerant may cause the A/C system being serviced to be undercharged because a significant amount of refrigerant meant for the A/C system is in the high-side hose and not the A/C system. Leaving a significant amount of refrigerant in a high-side hose rather than entering it into the A/C system will undercharge the A/C system which can result in poor A/C system performance.

Accordingly, it is desirable to provide a method and apparatus that allows refrigerant from the high-side hose of the charging unit to equalize (thus causing refrigerant from the high side of the system to enter the A/C system) with the low side of the A/C system after the high-side hose is removed from the A/C system.

### SUMMARY OF THE INVENTION

The foregoing needs are met, to a great extent, by the present invention, wherein in one aspect an apparatus is provided that in some embodiments a method and apparatus is provided that allows refrigerant from the high-side hose of the charging unit to equalize (thus causing refrigerant from the high side of the system to enter the A/C system) with the low side of the A/C system after the high-side hose is removed from the A/C system.

In accordance with one embodiment of the present invention, a method putting refrigerant from a high-pressure hose on a charging device connected to an A/C system by a high-pressure hose and a low-pressure hose to the A/C system is provided. The method includes: disconnecting the high-pressure hose from the A/C system, energizing solenoid valves located in both the high and low-pressure hoses to provide fluid communication between the interiors of the high and low-pressure hoses, and flowing refrigerant from the high-pressure-hose to the A/C system via the low-pressure hose.

In accordance with another embodiment of the present invention, a storage media containing executable code for a method putting refrigerant from a high-pressure hose on a charging device connected to an A/C system by a high-pressure hose and a low-pressure hose to the A/C system is provided. The method includes prompting a user to disconnect the high-pressure hose from the A/C system, energizing solenoid valves located in both the high and low-pressure hoses to provide fluid communication between the interiors of the high and low-pressure hoses, and flowing refrigerant from the high-pressure hose to the A/C system via the low-pressure hose.

In accordance with yet another embodiment of the present invention, an apparatus for clearing a high-pressure hose of refrigerant is provided. The apparatus includes a first solenoid valve connected in to the high-pressure-hose and configured to selectively permit flow of refrigerant through the high-pressure hose, a second solenoid valve connected to a low-pressure hose and configured to selectively permit flow of refrigerant through the low-pressure hose, a pressure transducer located between the first and second solenoid valves and configured to determine a pressure in a conduit connecting the high and low-pressure hoses, a controller operatively connected to the first and second solenoid valves to selectively provide fluid communication between the high and low-pressure valves via the conduit, the controller also operatively connected to the pressure transducer.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating components of a charging machine used to accomplish clearing of the high-side hose according to an embodiment of the invention.

FIG. 2 is a schematic diagram illustrating components of a charging machine used to accomplish clearing of the high-side hose according to a second embodiment of the invention.

FIG. 3 is a flowchart illustrating steps that may be followed in accordance with one embodiment of the method or process of clearing the high-side hose of a recovery unit.

### DETAILED DESCRIPTION

The invention will now be described with reference to the drawing figures, in which like reference numerals refer to like parts throughout. An embodiment in accordance with the present invention provides a recovery unit that allows refrigerant from the high-side hose of the charging unit to equalize (thus causing refrigerant from the high-side of the system to enter the A/C system) with the low side of the A/C system before the high-side hose is removed from the A/C system.

Examples or aspects of recovery units are described in at least some of U.S. Pat. Nos. D433,346; 4,938,031; 5,005,369; 5,248,125; 4,261,178; 4,768,347; 4,809,520; 5,603,223; 6,202,433; 6,334,320; 6,119,475; 6,134,899; 6,134,896; 6,138,462; 5,906,106 and U.S. patent application Ser. No. 10/178,526, all of which are incorporated herein in their entirety.

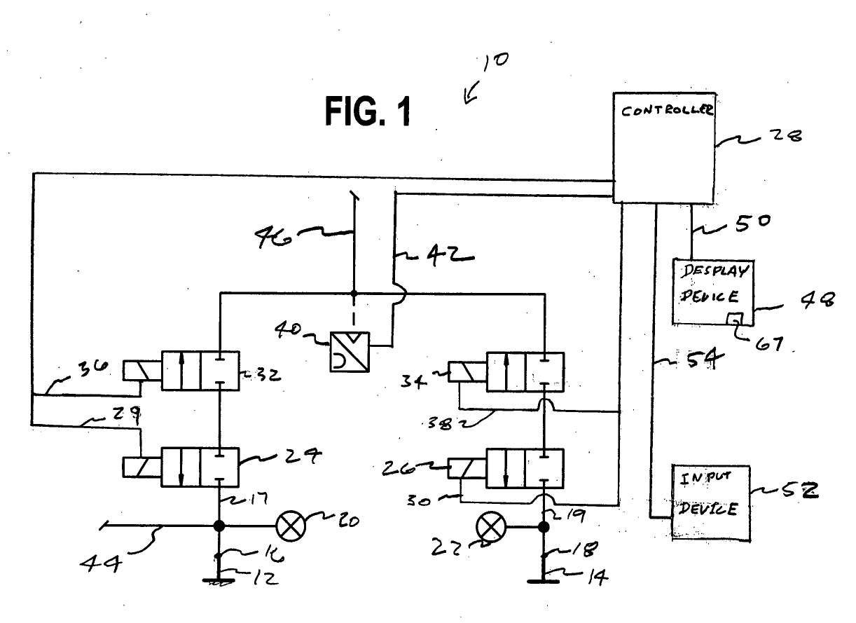

FIG. 1 is a schematic diagram of a portion 10 of a recovery unit that is involved in the hose clearing operation in accordance with the invention. Connections to the air conditioning system of a vehicle are illustrated by items 12 and 14 where item 12 is the high side of the system or, in other words, the side of the air conditioning system on the discharge side of a compressor, and connector 14 is the connector of the low side of the air conditioning system 14, which is on the suction side of the compressor or, in other words, the part of the air conditioning system just before the refrigerant enters the compressor. The hose clearing apparatus 10 of the recovery unit connects to the high side of the system 12 by a fitting 16 mounted to a high-pressure hose 17, and the low side of the system 10 connects to the low side of the air conditioning system 14 by fitting 18 mounted to a low-pressure hose 19. Two gauges 20 and 22 are connected to the system 10 and configured to provide a visual indication of the pressure within the high-pressure hose 17 and low-pressure hose 19, respectively. The high-side gauge is shown as reference numeral 20, and the low-side gauge is shown as reference numeral 22. The high-side gauge 20 is located on the high-pressure hose 17 between the fitting 16 and the solenoid valve 24. The low-pressure gauge 22 is located on the low-pressure hose 19 between the fitting 18 and the solenoid valve 26. The fittings 16 and 18 also prevent refrigerant from escaping the hoses 17 and 19 when the hoses 17 and 19 are disconnected from the air conditioning system.

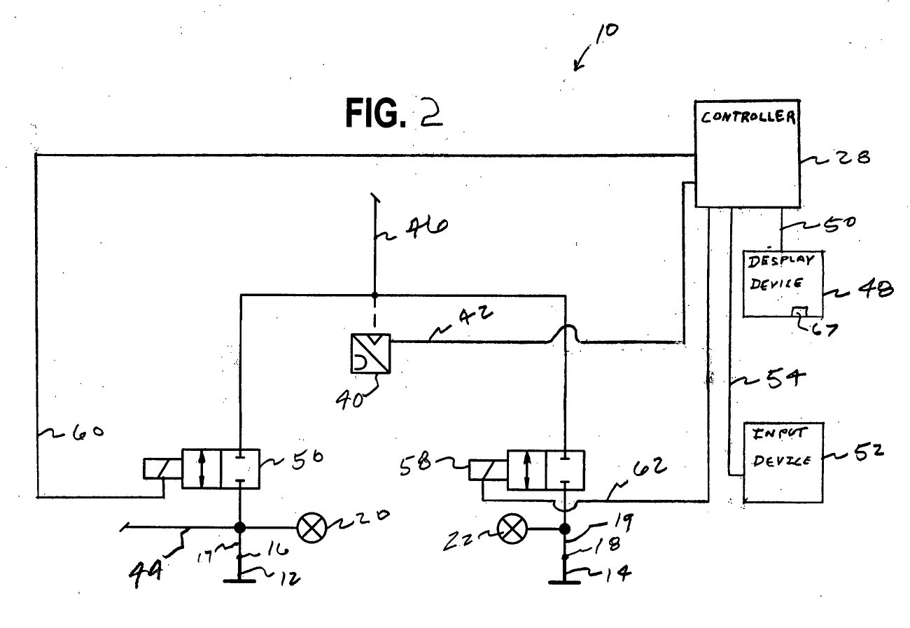

Both solenoid valves 24 and 26 are connected to a controller 28 by connections 29 and 30. The controller 28 will be described in more detail below. A second set of solenoid valves 32 and 34 are also shown in FIG. 1 and are connected to the controller 28 by connections 36 and 38. The high-pressure hose 17 has two solenoid valves 24 and 32, and the low-pressure hose 19 has two solenoid valves 26 and 34. Some embodiments of the invention, as shown in FIG. 1, use two solenoid valves on the high-pressure hose 17 and two solenoid valves on the low-pressure hose 19. Two solenoid valves are used when the solenoid valves are one-way valves only. If two-way solenoid valves were used, as shown in FIG. 2, then the system 10 would need only one solenoid valve for the high-pressure hose 17 and one solenoid valve for the low-pressure hose 19, as indicated by FIG. 2.

A transducer 40 is located in the system 10 and configured to provide a reading of the pressure of the refrigerant in the recovery unit. The transducer 40 is connected to the controller 28 by a connection 42. The transducer 40 gives a signal to the controller 28 of what the pressure is within the recovery unit 10 at the location of the transducer 40.

The hydraulic fluid path 46 is truncated in FIG. 1 to illustrate the fluid path leading to elements of the charging unit not relevant to the invention. In fact, the portion of the hydraulic diagram 10 shown in FIG. 1 could be applied to a variety of different charging units having different configurations whether available already in the art or yet to be invented, and those charging units could interface with the apparatus shown in the schematic diagram of FIG. 1 at hydraulic line 46.

In addition, hydraulic line 44 is a line connected to an oil recovery unit not relevant to the invention. The oil recovery unit helps separate lubricating oil from the refrigerant, but the oil separating process is not relevant to the invention, and several different oil separating processes could be used in accordance with the invention and may interface with the schematic illustrated in FIG. 1 at hydraulic line 44 in accordance with the invention. Alternatively, also in accordance with the invention, no oil separating unit could also be incorporated, or it could be incorporated at some other point and interface at some other portion of the diagram shown in FIG. 10 that could be appreciated by one skilled in the art.

The controller 28, in addition to receiving inputs from solenoid valves 24, 26, 32 and 34, also receives inputs from an input device 52. The input device 52 could be a simple keypad, or it could be some other input device such as a mouse or any other suitable input device. The input device 52 is connected to the controller 28 by a connection 54. This could be a wire or wireless connection as well as any of the other connections mentioned herein.

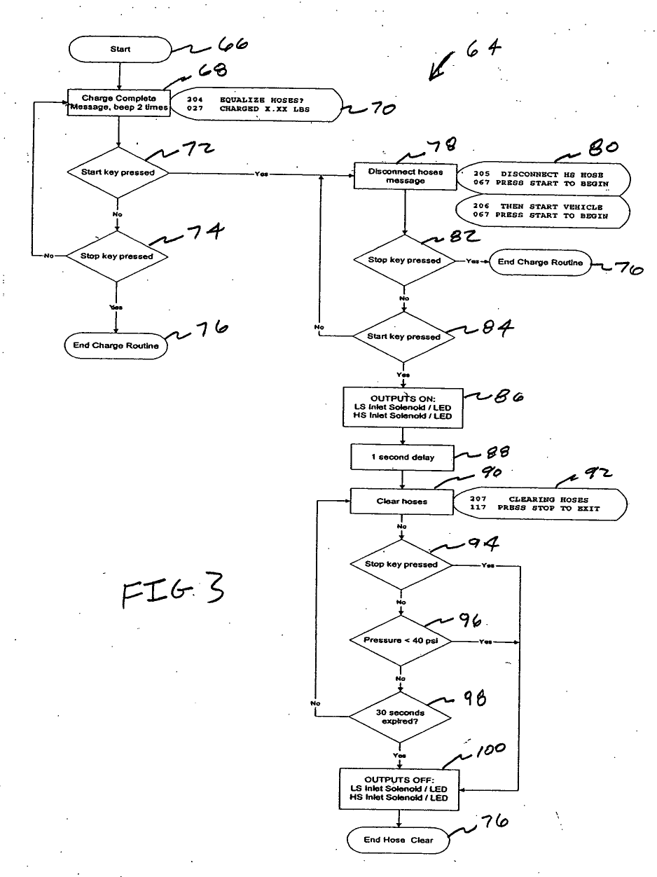

The controller 28 also has an output to a display device 48 connected to the controller 28 by a connection 50. The display device 48 can display certain commands or status to a user of the charging unit. Some of these display commands will be described later with respect to FIG. 3. The controller 28 also outputs to the solenoid valves 24, 26, 32 and 34 to operate the solenoid valves in accordance with the steps outlined and discussed later with respect to FIG. 3.

FIG. 2 is a schematic diagram of a second embodiment of the present invention showing the hose clearing apparatus 10 of a recovery unit. The A/C system has a high-pressure connection 12 and a low-pressure connection 14. The portion 10 of the recovery unit connects to the high side of the air conditioning system 12 at fitting 16 and to the low side of the air conditioning system 14 and connection 18. Gauges 20 and 22 illustrate the refrigerant pressure within the hoses 17, 19 connected to the high and low side of the A/C systems, respectively. Solenoid valve 56 is a two-way solenoid valve with permits refrigerant to flow either way through the valve 56. Valve 56 is connected to the controller 28 via connection 60, and valve 56 is connected to the high-pressure hose 17. Solenoid valve 58 is a two-way solenoid valve and is connected to the controller 28 via connection 62. Solenoid valve 58 is connected to the low-side hose 19. The pressure transducer 40 is connected to the controller 28 via connector 42. The pressure transducer 40 provides a signal to the controller 28 indicating the pressure of the refrigerant. Conduits 44 and 46 provide connections to the hose clearing portion 10 of the recovery unit not relevant to the invention. A display device 48 is connected to the controller 28 via connection 50. The display device include a LED display device or any other screen capable of displaying messages to a user. Input device 52 is, in some embodiments of the invention, a keypad but may be any other suitable input device and is connected to the controller 28 via connection 54.

FIG. 3 is a flow diagram illustrating a method in accordance with the invention. The method can be embodied in a software program storage media, or otherwise loaded onto the controller 28 to cause the controller 28 to operate the apparatus 10 in accordance with the invention. The method 64, in some embodiments of the invention, is a computer program that can be programmed onto the controller 28. In some embodiments of the invention, the program will prompt the user and display certain commands on the display device 48 and will operate the valves 24, 26, 32 and 34, or 56 and 58, as appropriate in accordance with the invention. The method 64 will also receive inputs from the input device 52 from the user.

According to some embodiments of the invention, a user in accordance with the invention, will disconnect the high-side hose 17 from the high side 12 of the air conditioning system. Then the air conditioning system will be turned on, which in some cases, when the air conditioning system is part of a vehicle, the vehicle to be started and the air conditioning system to be turned on. The controller 28 will energize the solenoid valves 24, 26, 32, 34 or 56 and 58 to provide fluid communication between the interior of the high-side hose 17 and the low-side hose 19. Because the high-side hose 17 is then connected to the low side of the air conditioning system 12 via the valves 24, 26, 32, 34 or 56 and 58 and the low-side hose 19, the air conditioning system's compressor will draw the refrigerant from the low-side hose 17 causing the refrigerant to flow from the high-side hose 17 into the air conditioning system to achieve the desired result.

The specific steps of the method 64 will now be described. The invention is in no way limited to the specific steps shown in 64, but rather defined by the claims. The method 64 is merely an example of one embodiment of the invention and is not meant to be limiting.

The start step 66 is initiated once the user has completed the other tasks associated with the evacuation unit not associated with the invention. Once those tasks have been completed, which are likely to include charging the air conditioning system of the vehicle, the hose clearing method 64 will then be initiated. Once the charge is completed, the display device 48, which may also include an audio portion 67, which is capable of sending audio signals such as a beep, will beep twice, thus getting the user's attention. Once the beeping step 68 has been completed, or concurrently with the beeping step 68, the input device 52 will ask the user whether the user desires to clear the hoses 17 and 19. Some embodiments of the input device will display the text shown in bubble 70, and some embodiments of the invention, the pressure protected by the pressure transducer 40 will be displayed in lieu of the X.XX indicated in the bubble 70.

At that time, the user will make a decision whether or not to undergo the hose clearing routine. In making a determination of whether or not to undertake the hose clearing routine, the user will view gauges 20 and 22 to determine if a large gap in pressure exists between the two gauges. Often, the high-side gauge 20 may indicate a pressure of 275-300 psi, and the low-side gauge may display a pressure of 55-40 psi. When the disparity in pressures are between the two hoses 17 and 19 are on this order, the user may determine to initiate the hose clearing routine.

If the user desires to not engage the hose clearing routine, then the user will press the stop key provided on the input device 52 (step 74) which will end the charge routine (step 76). If the user decides to go ahead and initiate the hose equalization routine, then the user will press the start key on the input device 52 and the starting of the hose clearing routine, step 72, will then initiate the hose clearing routine.

Once the hose clearing routine has been initiated, the next step, step 78, is to disconnect the high-pressure hose 17 from the air conditioning system high-pressure point 12. The display device 48, may in some embodiments of the invention, display the text indicated in bubble 80, which gives the instructions of disconnecting the high-pressure hose 17. Once the high-pressure hose is disconnected, the user then presses “start” to begin. The display device 48 then prompts the user to start the vehicle. Once the vehicle is started and the A/C system is turned on, the start key in the input device 52 is pressed by the user. If, at this point, the user decides to stop the equalization routine, the stop key may be pressed, step 82, which will end the charge routine (step 76). If, however, the user continues the process and starts the vehicle and the air conditioning system, then returns to the recovery unit, the user will then press the start key 84 on the input device 52 which will then indicate to the controller 28 that the air conditioning system is running and to continue with the system.

Once the motor has started and the air conditioning system is turned on, then the operator will press the “start” key; this is step 84, as shown in FIG. 3. Once the start key has been pressed on the input device 52, the controller 28 will give an electronic signals to the high and low-side solenoid valves 24,26,32 and 34, or in the instance where the valves are two-way, 56 and 58 to be actuated to the on position to allow refrigerant to flow through the valves to connect the high-side hose 17 to the low-side hose 19 via the system 10. The vehicle's A/C system will evacuate the refrigerant in the high-pressure hose 17 through the system 10 and the low-pressure hose 19, which is still physically connected to the low side 14 of the A/C system.

In some embodiments of the invention, an LED light or other indicator may come on in the display device 48 or in some other area where an LED light may be located to let the operator know that the solenoid valves 24, 26, 32 and 34 or 56 and 58 are in the energized position. After the output step has been completed, the next step 88 is for a one second delay. This is an optional step and may or may not be present in all embodiments of the invention.

After the one second delay step 88, the next step 90 is to display on the display device 48, a message to the user. An example of the message, in accordance with the invention, is shown in bubble 92 and can indicate that the machine is clearing hoses and the operator can press the stop key on the input device 52 at any time to stop the hose clearing process. Should the stop button be pressed, as step 94, then the output to the valves 24, 26, 32 and 34, or 56 and 58 will stop being energized causing them to move to the closed position and not allow them to pass fluid through them, thus cutting off fluid communication between the hoses 17 and 19 and the vehicle air conditioning system. This output off step 100 will be

What is claimed is:

1. A method putting refrigerant from a high-pressure hose on a charging device connected to an A/C system by a high-pressure hose and a low-pressure hose to the A/C system comprising:
disconnecting the high-pressure hose from the A/C system;
energizing solenoid valves located in both the high and low-pressure hoses to provide fluid communication between the interiors of the high and low-pressure hoses; and
flowing refrigerant from the high-pressure-hose to the A/C system via the low-pressure hose.

2. The method of claim 1, wherein the A/C system is associated with a vehicle.

3. The method of claim 2, further comprising prompting a user to start the vehicle.

4. The method of claim 2, further comprising starting the vehicle.

5. The method of claim 4, further comprising turning on the A/C system.

6. The method of claim 1, further comprising turning on the A/C system.

7. The method of claim 1, further comprising de-energizing the solenoid valves when a pressure within the hoses falls below about 40 psi.

8. The method of claim 7, further comprising detecting the pressure within the hoses.

9. The method of claim 1, further comprising de-energizing the solenoid valves once the solenoid valves have been energized for about 30 seconds.

10. The method of claim 1, further comprising prompting a user to disconnect the high-pressure hoses.

11. The method of claim 1, further comprising prompting a user that the hoses are being cleared.

12. The method of claim 11, further comprising delaying about one second between energizing the solenoid valves and prompting the user that the hoses are being cleared.

13. The method of claim 1, further comprising asking a user if it is desired to equalize the hoses.

14. A storage media containing executable code for a method putting refrigerant from a high-pressure hose on a charging device connected to an A/C system by a high-pressure hose and a low-pressure hose to the A/C system comprising:
prompting a user to disconnect the high-pressure hose from the A/C system;
energizing solenoid valves located in both the high and low-pressure hoses to provide fluid communication between the interiors of the high and low-pressure hoses; and
flowing refrigerant from the high-pressure hose to the A/C system via the low-pressure hose.

15. The storage media containing executable code for a method of claim 14, further comprising prompting a user to start the vehicle.

16. The storage media containing executable code for a method of claim 14, further comprising prompting a user to turn on the A/C system.

17. The storage media containing executable code for a method of claim 14, further comprising de-energizing the solenoid valves when a pressure within the hoses falls below about 40 psi.

18. The storage media containing executable code for a method of claim 14, further comprising detecting the pressure within the hoses.

19. The storage media containing executable code for a method of claim 14, further comprising de-energizing the solenoid valves once the solenoid valves have been energized for about 30 seconds.

20. The storage media containing executable code for a method of claim 14, further comprising prompting a user to disconnect the high-pressure hoses.

21. The storage media containing executable code for a method of claim 14, further comprising prompting a user that the hoses are being cleared.

22. The storage media containing executable code for a method of claim 14, further comprising delaying about one second between energizing the solenoid valves and prompting the user that the hoses are being cleared.

23. The storage media containing executable code for a method of claim 14, further comprising asking a user if it is desired to equalize the hoses.

24. An apparatus for clearing a high-pressure hose of refrigerant comprising:
a first solenoid valve connected in to the high-pressure-hose and configured to selectively permit flow of refrigerant through the high-pressure hose;
a second solenoid valve connected to a low-pressure hose and configured to selectively permit flow of refrigerant through the low-pressure hose;
a pressure transducer located between the first and second solenoid valves and configured to determine a pressure in a conduit connecting the high and low-pressure hoses;
a controller operatively connected to the first and second solenoid valves to selectively provide fluid communication between the high and low-pressure valves via the conduit, the controller also operatively connected to the pressure transducer.
